(19) United States
(12) Patent Application Publication
(10) Pub. No.: US 2026/0213681 A1
(43) Pub. Date: Jul. 23, 2026

(54) CONTROL METHOD OF PULSE POWER TOOL

(71) Applicant: MOBILETRON ELECTRONICS CO., LTD., Taichung City (TW)

(72) Inventor: PO-KAI DAI, Pingtung County (TW)

(73) Assignee: MOBILETRON ELECTRONICS CO., LTD., Taichung City (TW)

(21) Appl. No.: 19/032,062

(22) Filed: Jan. 19, 2025

Related U.S. Application Data
(60) Provisional application No. 63/716,726, filed on Nov. 6, 2024.

(51) Int. Cl. H02P 6/08; B25B 21/02; B25B 23/147

(52) U.S. Cl. CPC H02P 6/08; B25B 21/02; B25B 23/1475

(57) ABSTRACT

A control method of a pulse power tool includes a setting step for setting a predetermined pulse number, controlling a motor to rotate, continuously obtaining a rotation speed signal based on a detecting result of a rotation speed detecting device and obtaining a current signal based on a detecting result of a current detecting device, obtaining a rotating time of each of several rotation angles of the motor based on a variation of several pulse waves of the rotation speed signal and obtaining a motor current based on the current signal, determining a number of the pulses produced by the pulse generation mechanism based on a variation of the rotating time and a variation of the motor current, controlling the motor to stop rotating when the number of the pulses reaches the predetermined pulse number. In this way, a torque outputted by the pulse power tool could be accurately controlled.

### BACKGROUND OF THE INVENTION

### Technical Field

The present invention relates generally to a power tool, and more particularly to a control method of a pulse power tool.

### Description of Related Art

Typically, a pulse power tool includes a motor and a pulse generation mechanism, wherein the motor drives the pulse generation mechanism to produce a plurality of pulses, thereby generating a torque through each of the pulses. The greater a number of the pulses is, the greater a torque value outputted to a workpiece is. The conventional pulse power tool could only output the fixed torque. However, the fixed torque could not be applied to the workpieces of various sizes. When a torque required to tighten the workpiece is greater than the torque value outputted by the pulse power tool, the workpiece could not be tightened. When the torque required to tighten the workpiece is less than the torque value outputted by the pulse power tool, the workpiece would be damaged.

Therefore, a pulse power tool with an adjustable torque output has also been developed. The conventional pulse power tool with the adjustable torque output adjusts the torque output by setting different operation times after generating a plurality of pulses, wherein the longer the operation time is set, the higher a number of the pulses are and the higher the torque produced are. However, the conventional pulse power tool could not obtain the number of the pulses produced by the pulse generation mechanism during the operation time, so the torque control is not accurate enough.

In addition, the pulse power tool further includes a battery, wherein the battery is adapted to provide an electrical power to the motor needing for operation. With consuming the electrical power of the battery, a voltage of the battery decreases. When the voltage of the battery decreases to a certain level, the torque of the pulses outputted by the pulse generation mechanism would decrease every time, especially the great torque outputted by the pulse generation mechanism decreases more obviously. In other words, even if the number of the pulses is identical, the torque with the insufficient voltage of the battery applied to the workpiece is less than the torque with the sufficient voltage of the battery, so that the torque control is not accurate enough.

### BRIEF SUMMARY OF THE INVENTION

In view of the above, the primary objective of the present invention is to provide a control method of a pulse power tool, which could provide a sufficient torque during a voltage of a battery decreasing.

The present invention provides a control method of a pulse power tool, wherein the pulse power tool includes a motor, a pulse generation mechanism, a rotation speed detecting device, a current detecting device, and at least one control device. The pulse generation mechanism is coupled to the motor and is driven by the motor to rotate. The rotation speed detecting device is adapted to detect a rotation speed of the motor and the current detecting device is adapted to detect a motor current when the motor operates. The control method is executed by the at least one control device and includes the following steps:
step A: a setting step for setting a predetermined pulse number includes the following steps:
obtaining an output voltage of the battery;
determining if the output voltage is greater than or equal to a predetermined voltage;
if the output voltage is greater than or equal to the predetermined voltage, the predetermined pulse number is set as a predetermined number according to a torque level;
if the output voltage is not greater than or equal to the predetermined voltage, the predetermined pulse number is set as the predetermined number plus a corresponding compensation pulse number according to the torque level;
step B: controlling the motor to rotate;
step C: continuously obtaining a rotation speed signal based on a detecting result of the rotation speed detecting device and obtaining a current signal based on a detecting result of the current detecting device, wherein the rotation speed signal has a plurality of pulse waves corresponding to a plurality of rotation angles of the motor; obtaining a rotating time of each of the rotation angles of the motor based on a variation of the pulse waves and obtaining the motor current based on the current signal;
step D: determining that the pulse generation mechanism produces a plurality of pulses based on a variation of the rotating time of the rotation speed signal and a variation of the motor current of the current signal, and obtaining a number of the pulses by summing the pulses produced be the pulse generation mechanism;
step E: determining if the number of the pulses reaches the predetermined pulse number; if the number of the pulses has not reached the predetermined pulse number, keep the motor continuously rotating; if the number of the pulses reaches the predetermined pulse number, stop the motor from rotating.

With the aforementioned design, the number of the pulses produced by the pulse generation mechanism could be accurately determined through the motor current and the rotating time of the rotation speed signal, and the motor could be controlled to stop rotating when the number of the pulses reaches the required predetermined pulse number, thereby accurately controlling the torque outputted by the pulse power tool. In addition, when the output voltage of the battery decreases, the torque is compensated through the corresponding compensation pulse number, thereby providing the sufficient torque applied to the workpiece.

### BRIEF DESCRIPTION OF THE SEVERAL VIEWS OF THE DRAWINGS

The present invention would be best understood by referring to the following detailed description of some illustrative embodiments in conjunction with the accompanying drawings, in which

FIG. 1 is a schematic view of the pulse power tool according to a first embodiment of the present invention;

FIG. 2 is a block diagram of the pulse power tool according to the first embodiment of the present invention;

FIG. 3 is a waveform diagram of the rotation speed signal according to the first embodiment of the present invention;

FIG. 4A is a flow chart of the control method of the pulse power tool according to the first embodiment of the present invention;

FIG. 4B is a flow chart of the setting step according to the first embodiment of the present invention;

FIG. 5 is a waveform diagram of the pulse power tool according to the first embodiment of the present invention;

FIG. 6 is a waveform diagram of the pulse power tool according to the first embodiment of the present invention;

FIG. 7 is a waveform diagram of the pulse power tool according to the first embodiment of the present invention;

FIG. 8 is a waveform diagram of the pulse power tool according to the first embodiment of the present invention;

FIG. 9 is a schematic view of the pulse power tool according to a second embodiment of the present invention;

FIG. 10 is a flow chart of the control method of the pulse power tool according to the second embodiment of the present invention;

FIG. 11 is a waveform diagram of the rotation speed signal according to the second embodiment of the present invention; and

FIG. 12 is a flow chart of the control method of the pulse power tool according to a third embodiment of the present invention.

### DETAILED DESCRIPTION OF THE INVENTION

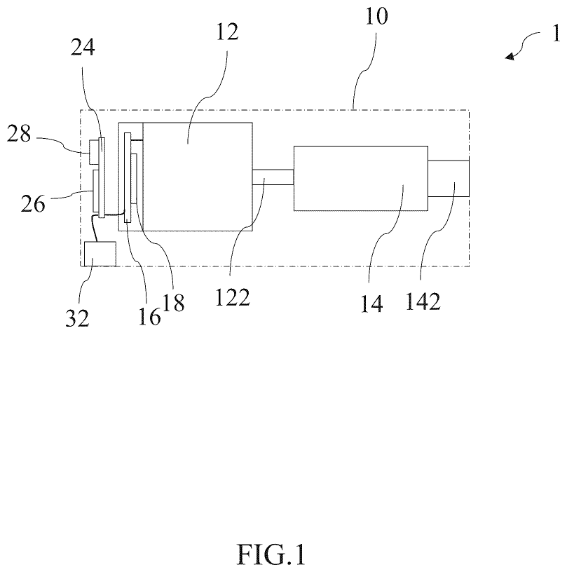

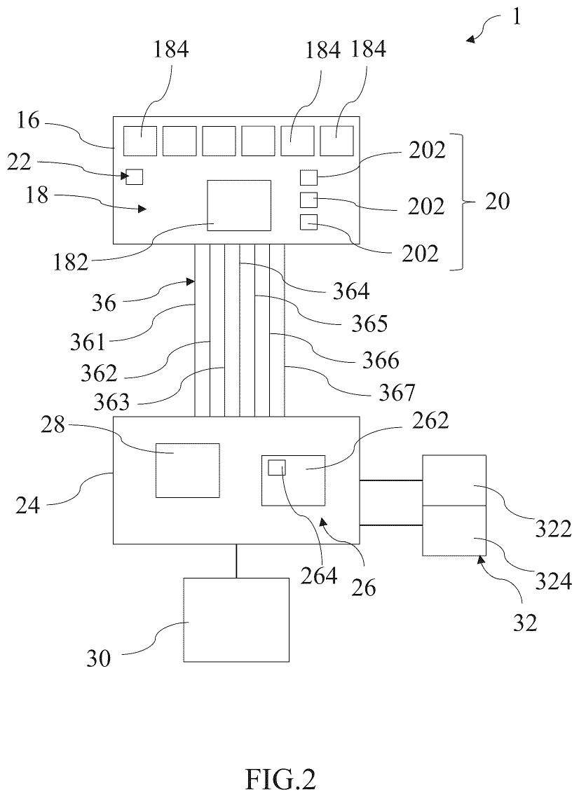

A pulse power tool 1 according to a first embodiment of the present invention is illustrated in FIG. 1 and FIG. 2 and is a pulse wrench as an example. The pulse power tool 1 includes a casing 10, a motor 12, a pulse generation mechanism 14, a first circuit board 16, and a second circuit board 24, wherein the motor 12, the pulse generation mechanism 14, the first circuit board 16, and the second circuit board 24 are disposed in the casing 10.

A rotating shaft 122 of the motor 12 is coupled to the pulse generation mechanism 14. The motor 12 is controlled to rotate. In the current embodiment, the motor 12 is a three-phase brushless DC motor as an example; the pulse generation mechanism 14 is a hydraulic pulse generation mechanism as an example, but not limited thereto. The pulse generation mechanism 14 could be a pulsed pulse generation mechanism.

The pulse generation mechanism 14 is driven by the motor 12 to rotate and is connected to an output shaft 142, wherein the output shaft 142 is adapted to be connected to a workpiece to be driven. During a process of a rotation of the pulse generation mechanism 14, the pulse generation mechanism 14 would produce a pulse when the output shaft 142 receives a certain resistance, wherein the pulse applies a predetermined torque to the workpiece every time.

A first control device 18, a rotation speed detecting device 20, and a current detecting device 22 are disposed on the first circuit board 16.

The first control device 18 is electrically connected to the motor 12 for controlling an operation of the motor 12. In the current embodiment, the first control device 18 includes a first controller 182 and a plurality of commutation switching elements 184, wherein the first controller 182 could be a microcontroller and is electrically connected to the commutation switching elements 184. In the current embodiment, the commutation switching elements 184 are six MOSFETs and are electrically connected to a stator of the motor 12.

The rotation speed detecting device 20 is adapted to detect a rotation speed of the motor 12 and outputs a rotation speed signal. In the current embodiment, the rotation speed detecting device 20 includes a plurality of Hall detectors 202 electrically connected to the first controller 182, wherein the Hall detectors 202 include three Hall detectors 202 which are respectively adapted to detect a position of a rotor of the motor 12. An output of each of the three Hall detectors 202 varies between a first voltage level V1 and a second voltage level V2, wherein the three Hall detectors 202 respectively output a pulse wave in sequence when the rotor rotates by per 120 degrees. In other words, the rotation speed signal includes the three outputs of the three Hall detectors 202, wherein a variation of each of the pulse waves represents that the motor 12 rotates by a rotation angle of 120 degrees as an example. In the current embodiment, the first voltage level V1 is a low voltage level as an example and the second voltage level V2 is a high voltage level as an example.

The second circuit board 24 is electrically connected to a battery 30 and an operation interface 32. A second control device 26 and a monitor 28 are disposed on the second circuit board 24. The battery 30 provides an electrical power to the second circuit board 24. The operation interface 32 is electrically connected to the second control device 26 and includes an activating switch 322 and a level selecting device 324, wherein the activating switch 322 is operated by a user to output a first activating signal or a second activating signal to the second control device 26. When the user lightly presses the activating switch 322, the first activating signal is outputted. When the user heavily presses the activating switch 322, the second activating signal is outputted. The second control device 26 is further adapted to detect an output voltage of the battery 30.

The level selecting device 324 could be a switch and is operated by the user to output a level selecting signal to the second control device 26, thereby selecting one of a plurality of different predetermined torque levels to form a torque level which the user required.

The second control device 26 includes a second controller 262 and a storage unit 264, wherein the second controller 262 could be a microcontroller and is electrically connected to the monitor 28. In the current embodiment, the storage unit 264 is a built-in memory of the second controller 262 and stores a plurality of reference numbers respectively corresponding to the predetermined torque levels. The higher the predetermined torque levels are, the more the reference numbers are. The second controller 262 could correspondingly select one of the reference numbers according to the level selecting signal. The storage unit 264 further stores a plurality of reference compensation pulse number groups respectively corresponding to the reference numbers and the predetermined torque levels. Each of the reference compensation pulse number groups includes a plurality of reference compensation pulse numbers. The reference compensation pulse numbers corresponding to the predetermined torque levels are adapted to compensate a decrease of a torque outputted by the pulse generation mechanism 14 and caused by the decreasing output voltage of the battery 30. Therefore, the pulse generation mechanism 14 could produce an extra number of the pulses to compensate an insufficiency of the torque.

Referring to Table 1, Table 1 is a corresponding table showing the predetermined torque levels, the reference numbers, the reference compensation pulse number groups, and a plurality of reference voltage differences. The corresponding table is stored in the storage unit 264. Referring to Table 1, that a value of each of the predetermined torque levels is greater represents that the corresponding torque is greater. Each of the reference compensation pulse numbers of each of the reference compensation pulse number groups corresponds to each of the reference voltage differences. Each of the reference voltage differences is a predetermined voltage minus each of the different output voltages of the battery 30. In the current embodiment, when the reference voltage differences corresponding to the predetermined torque levels are identical, the reference compensation pulse numbers corresponding to the predetermined torque levels are not identical, but not limited thereto. When the reference voltage differences corresponding to the predetermined torque levels are identical, the reference compensation pulse numbers corresponding to the predetermined torque levels could be identical. The predetermined voltage could be stored in the storage unit 264 to be read by the second controller 262.

TABLE 1

| | | Reference | |
|---|---|---|---|
| Predetermined | Reference | compensation | Reference voltage |
| torque level | number | pulse number | difference (V) |
| 1 | 10 | 1 | 0.1 |
| | | 2 | 0.2 |
| | | 3 | 0.3 |
| | | 4 | 0.4 |
| | | 5 | 0.5 |
| 2 | 15 | 2 | 0.1 |
| | | 3 | 0.2 |
| | | 4 | 0.3 |
| | | 5 | 0.4 |
| | | 6 | 0.5 |
| 3 | 20 | 3 | 0.1 |
| | | 4 | 0.2 |
| | | 5 | 0.3 |
| | | 6 | 0.4 |
| | | 7 | 0.5 |

Each of the reference compensation pulse numbers corresponding to each of the predetermined torque levels is directly proportional to each of the reference voltage differences, i.e., each of the reference compensation pulse numbers corresponding to each of the predetermined torque levels is inversely proportional to the output voltage of the battery 30. In other words, the lower the output voltage of the battery 30 is (i.e., the greater the reference voltage differences are), the more the reference compensation pulse numbers are. The reference compensation pulse numbers are utilized when the output voltage of the battery 30 is less than the predetermined voltage. When the output voltage of the battery 30 is greater than or equal to the predetermined voltage, the reference compensation pulse numbers are not utilized, i.e., the torque is not compensated through the reference compensation pulse numbers.

In the current embodiment, the second control device 26 detects the output voltage of the battery 30 through the second controller 262.

The second circuit board 24 is electrically connected to the first circuit board 16 through a transmission line group 36. A plurality of transmission lines of the transmission line group 36 includes a power cord 361, a ground wire 362, a command transmission line 363, a brake signal line 364, a feedback signal line 365, a current signal line 366, and a rotation speed signal line 367. The power cord 361 and the ground wire 362 are adapted to transmit the electrical power from the second circuit board 24 to the first circuit board 16. The second control device 26 communicates with the first control device 18 through the command transmission line 363, the brake signal line 364, the feedback signal line 365, the current signal line 366, and the rotation speed signal line 367.

The second control device 26 transmits a pulse width modulation signal to the first control device 18 through the command transmission line 363, wherein the pulse width modulation signal is used as a command for controlling a rotation mode of the motor 12. More specifically, a pulse frequency of the pulse width modulation signal represents a rotation direction of the motor 12 and a duty cycle of the pulse width modulation signal represents a rotation speed of the motor 12. The first control device 18 analyzes the pulse frequency of the pulse width modulation signal to correspondingly control the rotation direction of the motor 12 and analyzes the duty cycle to correspondingly control the rotation speed of the motor 12. In an embodiment, the command transmission line 363 could be replaced by two transmission lines, wherein one of the two transmission lines transmits a rotation direction command and the other transmission line transmits a rotation speed command, so that the first control device 18 controls the rotation direction of the motor 12 according to the rotation direction command and controls the rotation speed of the motor 12 according to the rotation speed command.

The second control device 26 transmits a braking command through the brake signal line 364. The first control device 18 controls the motor 12 to stop rotating according to the braking command.

The first control device 18 correspondingly transmits a pulse generation signal through the feedback signal line 365, wherein the pulse generation signal corresponds to an operation state of the pulse generation mechanism 14. A way to produce the pulse generation signal would be described in detail later.

The current detecting device 22 detects a motor current Im when the motor 12 operates and outputs a current signal to the first control device 18, wherein the current signal could be transmitted to the second control device 26 through the current signal line 366.

The feedback signal line 365 of the transmission line group 36 is a first transmission line defined in the present invention and the brake signal line 364 is a second transmission line defined in the present invention.

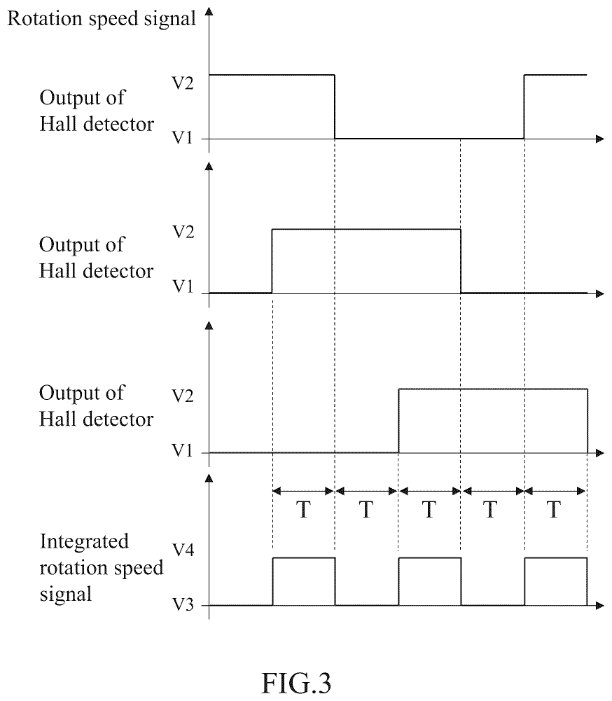

In the current embodiment, because the original rotation speed signal includes the three outputs of the three Hall detectors 202, the first controller 182 converts the three outputs of the three Hall detectors 202 into an integrated rotation speed signal for facilitating the second control device 26 to determine the rotation speed, wherein the integrated rotation speed signal is transmitted to the second control device 26 through the rotation speed signal line 367, so that the second control device 26 determines the rotation speed of the motor 12. Referring to FIG. 3, in the current embodiment, the first controller 182 varies the integrated rotation speed signal from a third voltage level V3 to a fourth voltage level V4 when the output of each of the three Hall detectors 202 varies from the first voltage level V1 to the second voltage level V2, and the first controller 182 varies the integrated rotation speed signal from the fourth voltage level V4 to the third voltage level V3 when the output of each of the three Hall detectors 202 varies from the second voltage level V2 to the first voltage level V1. In the current embodiment, the third voltage level V3 is the low voltage level as an example and the fourth voltage level V4 is the high voltage level as an example. In other words, every time the rotor rotates by 120 degrees, the integrated rotation speed signal would have a pulse wave change of one cycle, and every time the rotor rotates for one revolution, the integrated rotation speed signal would have a pulse wave of three cycles. The second control device 26 could calculate the rotation speed of the rotor based on a pulse wave cycle of the integrated rotation speed signal. Through integrating the three outputs of the three Hall detectors 202 into one, a number of the transmission lines of the transmission line group 36 could be effectively reduced.

A pulse wave of the original rotation speed signal or the pulse wave change of one cycle of the integrated rotation speed signal represents the rotation angle of the rotating shaft 122 of the motor 12. In the current embodiment, the rotation angle that the pulse wave change of one cycle corresponds to is 120 degrees.

In an embodiment, the first controller 182 could transmit the output of one of the three Hall detectors 202 in the original rotation speed signal to the second control device 26 through the rotation speed signal line 367; the second control device 26 calculates the rotation speed of the rotor through the pulse wave cycle outputted by one of the three Hall detectors 202. In addition, if the second control device 26 does not need to obtain the rotation speed, the rotation speed signal line 367 could be omitted.

In an embodiment, the first control device 18 and the second control device 26 could be integrated into a control device and could be located on an identical circuit board.

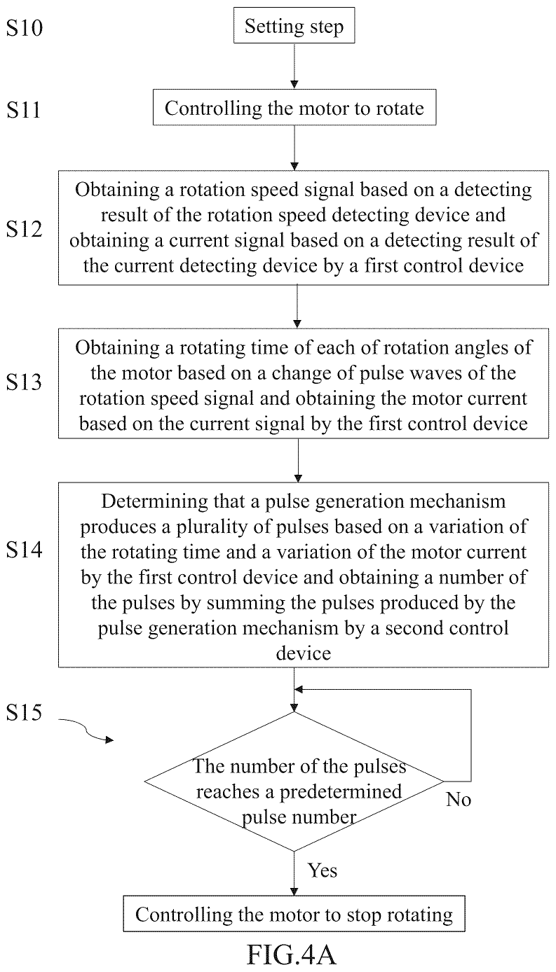

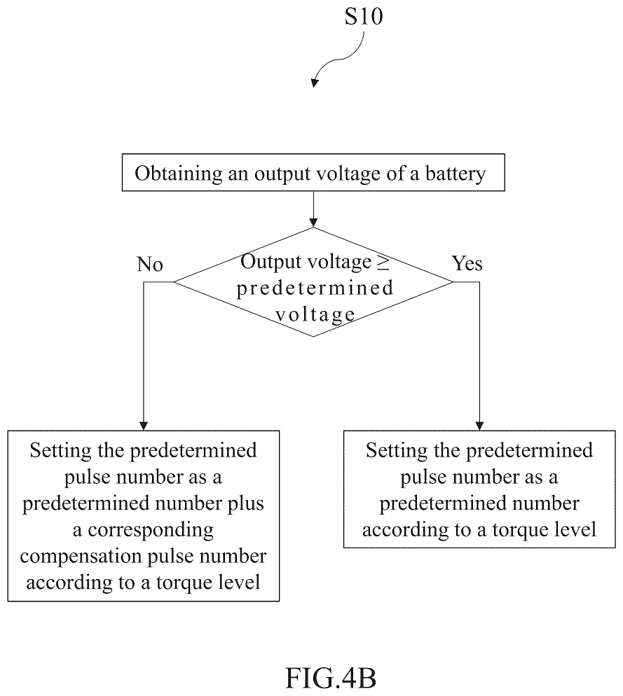

With the aforementioned structure of the pulse power tool 1, a control method as shown in FIG. 4A could be applied, wherein the control method is executed by at least one control device. In the current embodiment, the at least one control device includes two control devices and the control method is executed by the two control devices (i.e., the first control device 18 and the second control device 26). The control method includes the following steps:

Step S10: executing a setting step, wherein the setting step is adapted to set a predetermined pulse number and is illustrated in FIG. 4B.

In the current embodiment, the user operates the operation interface 32 to select the required one of the torque levels through the level selecting device 324; the level selecting device 324 correspondingly outputs the level selecting signal to the second control device 26; the second controller 262 displays the torque level selected by the user through the monitor 28.

The second controller 262 detects the output voltage of the battery 30 to obtain the output voltage of the battery 30 and selects one of the predetermined torque levels according to the level selecting signal to form the torque level. The second controller 262 obtains the corresponding predetermined number based on the corresponding table stored in the storage unit 264 according to the torque level (i.e., one of the predetermined torque levels corresponding to the level selecting signal).

The second controller 262 determines if the output voltage of the battery 30 is greater than or equal to the predetermined voltage.

If the output voltage of the battery 30 is greater than or equal to the predetermined voltage, the second controller 262 sets the predetermined pulse number according to the torque level and the predetermined pulse number is equal to the predetermined number corresponding to the torque level, i.e., the torque is not compensated through the compensation pulse number.

If the output voltage of the battery 30 is not greater than or equal to the predetermined voltage, the second controller 262 sets that the predetermined pulse number is equal to the predetermined number plus the corresponding compensation pulse number according to the torque level, i.e., the torque is compensated through the compensation pulse number. More specifically, the second controller 262 subtracts the current output voltage of the battery 30 from the predetermined voltage to obtain a practical voltage difference. Subsequently, the second controller 262 obtains the corresponding reference number and the corresponding reference compensation pulse number from the corresponding table stored in the storage unit 264 according to the torque level (i.e., one of the predetermined torque levels corresponding to the level selecting signal) and the voltage difference. The reference number obtained by the second controller 262 forms the predetermined number and the reference compensation pulse number obtained by the second controller 262 forms the compensation pulse number. The second controller 262 adds the predetermined number to the compensation pulse number to obtain the predetermined pulse number. Preferably, the second controller 262 selects one of the reference compensation pulse numbers corresponding to one of the reference voltage differences which is identical to or similar to the voltage difference as the corresponding compensation pulse number. When the voltage difference is a mean of the two adjacent reference voltage differences, the second controller 262 averages the two reference compensation pulse numbers corresponding to the two adjacent reference voltage differences to obtain the corresponding compensation pulse number.

Preferably, the predetermined voltage is less than a rated voltage of the battery 30. For example, the rated voltage of the battery 30 is 24V and the predetermined voltage is 22V. For example, when the torque level is 1, the output voltage is 21.8V, and the voltage difference is 0.2V, the reference number (i.e., the predetermined number) obtained by the second controller 262 form the corresponding table (as shown in Table 1) stored in the storage unit 264 is 10, the reference compensation pulse number (i.e., the compensation pulse number) obtained by the second controller 262 from the corresponding table (as shown in Table 1) stored in the storage unit 264 is 2, and the predetermined pulse number is set as 12.

Step S11: controlling the motor 12 to rotate.

After the user lightly presses the activating switch 322, the activating switch 322 outputs the first activating signal to the second controller 262, the second controller 262 outputs the corresponding pulse width modulation signal to the first control device 18 through the command transmission line 363, and the first controller 182 controls the commutation switching elements 184 according to the pulse frequency of the pulse width modulation signal and the duty cycle of the pulse width modulation signal, thereby controlling the motor 12 to rotate. At that time, the rotating shaft 122 of the motor 12 drives the pulse generation mechanism 14 to rotate and the output shaft 142 drives the workpiece to rotate.

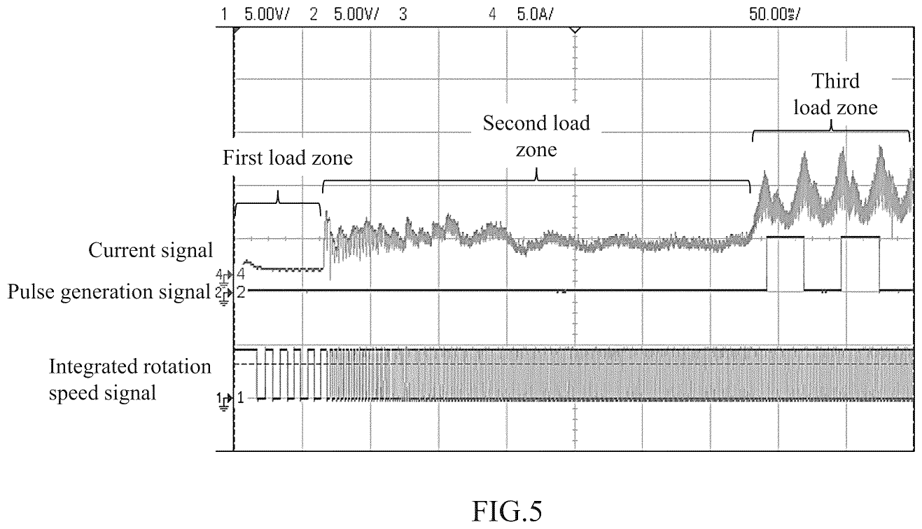

Referring to FIG. 5, a process of a rotation of the motor 12 could be divided into a first load zone, a second load zone, and a third load zone. During the first load zone, a rotation resistance of the motor 12 is the least and the motor current Im is the least.

Step S12: continuously obtaining the rotation speed signal based on a detecting result of the rotation speed detecting device 20 and obtaining the current signal based on a detecting result of the current detecting device 22.

In the current embodiment, the first controller 182 continuously converts the original rotation speed signal detected by the rotation speed detecting device 20 into the integrated rotation speed signal.

Referring to FIG. 5, the rotation resistance of the motor 12 gradually increases as the workpiece is gradually fastened. At that time, when the user heavily presses the activating switch 322, the activating switch 322 outputs the second activating signal to the second controller 262 and the second controller 262 outputs the corresponding pulse width modulation signal through the command transmission line 363, thereby commanding the first control device 18 to control the motor 12 to rotate at a fixed rotation speed and the process of the rotation of the motor 12 to enter the second load zone. The fixed rotation speed is greater than the rotation speed of the motor 12 in the first load zone. During the second load zone, the rotation speed gradually decreases and the motor current Im of the motor 12 gradually increases as the workpiece is gradually fastened.

As the workpiece is further fastened, the rotation resistance of the motor 12 further increases and the process of the rotation of the motor 12 enters the third load zone. During the third load zone, the rotation speed of the motor 12 is much lower, the motor current Im increases, and the pulse generation mechanism 14 produces the pulses. How the first control device 18 determines that the pulse generation mechanism 14 produces the pulses would be described in detail herein.

Step S13: the first control device 18 obtains a rotating time T of each of the rotation angles of the motor 12 based on a change of the pulse waves of the rotation speed signal and obtains the motor current Im based on the current signal.

Referring to FIG. 3, a time difference between a time that the pulse wave of the output of one of the three Hall detectors 202 varies and a time that the pulse wave of the output of another one of the three Hall detectors 202 varies in the rotation speed signal is the rotating time T. In other words, the rotating time T is obtained through the pulse wave change of the integrated rotation speed signal. In the below description, that the rotating time T is obtained by the pulse wave change of the integrated rotation speed signal is illustrated as an example, but not limited thereto. In other embodiments, the rotating time T of each of the rotation angles of the motor 12 could be obtained based on a variation of the outputs of the three Hall detectors 202 according to the original rotation speed signal.

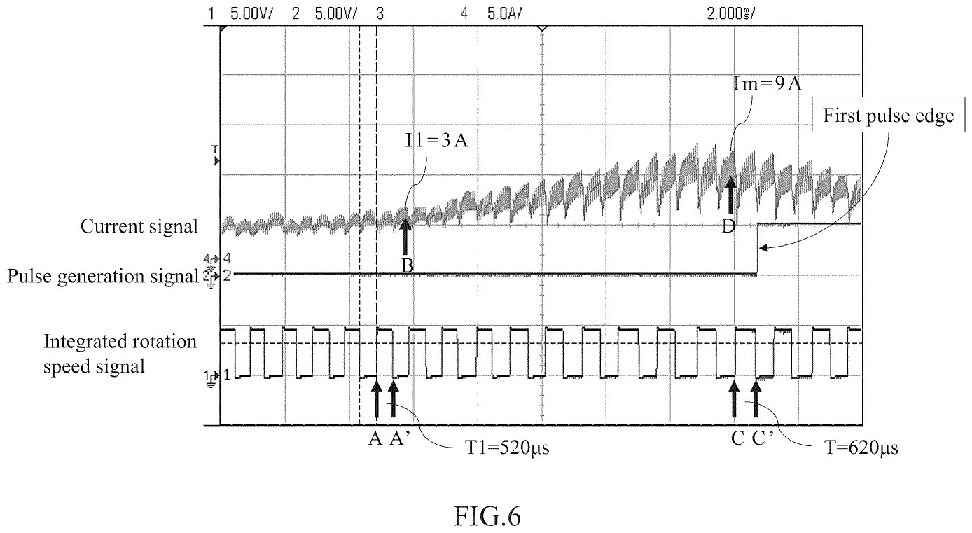

Referring to FIG. 6, in the current embodiment, after the motor 12 rotates at the fixed rotation speed (i.e., in the second load zone), the first control device 18 takes the rotating time T of one of the pulse waves in the integrated rotation speed signal as a first base time T1 (e.g., the first base time T1 between an arrow A and an arrow A′ in FIG. 6 is 520 μs) and takes the motor current Im of the current signal as a first base current I1 (e.g., the place pointed by arrow B in FIG. 6 is 3A). The rotating time T and the first base time T1 could be, but not limited to, a time of the high voltage level between a rising edge and a falling edge as an example. In other embodiments, the rotating time T and the first base time T1 could be a time of the low voltage level between the falling edge and the rising edge.

In an embodiment, the first base time T1 and the first base current I1 could respectively be a time value and a current value predetermined by the first control device 18.

Step S14: the first control device 18 determines that the pulse generation mechanism 14 produces the pulses according to a variation of the rotating time T and a variation of the motor current Im of the current signal and the second control device 26 counts a number of the pulses.

Referring to FIG. 6, when the first control device 18 determines that the variation of the rotating time T and the variation of the motor current Im satisfy a first condition, the first control device 18 determines that the pulse generation mechanism 14 produces a first pulse, wherein the first condition is that a ratio of the obtained rotating time T (e.g. the rotating time T between an arrow C and an arrow C′ in FIG. 6 is 620 μs) to the first base time T1 reaches a first ratio and a ratio of the obtained motor current Im (e.g. the place pointed by arrow D in FIG. 6 is 9A) to the first base current I1 reaches a second ratio.

In the current embodiment, the first base time T1 is 520 μs as an example and the first ratio is 1.19 as an example. In other words, when the obtained rotating time T is more than 618.8 μs, the first ratio is reached. Preferably, the first ratio ranges between 1.1 and 1.25. In an embodiment, the first ratio ranges between 1.15 and 1.2.

In the current embodiment, the first base current I1 is 3A as an example and the second ratio is 3 as an example. In other words, when the obtained motor current Im is more than 9A, the second ratio is reached. Preferably, the second ratio ranges between 1.5 and 4.5. In an embodiment, the second ratio ranges between 2.5 and 3.5. In an embodiment, the second ratio ranges between 2.8 and 3.2.

When the first condition is satisfied, the first control device 18 starts generating the pulse generation signal and converts the pulse generation signal from the first voltage level V1, which is the low voltage level as an example, into the second voltage level V2, which is the high voltage level as an example, thereby forming a first pulse edge of a pulse wave of the pulse generation signal.

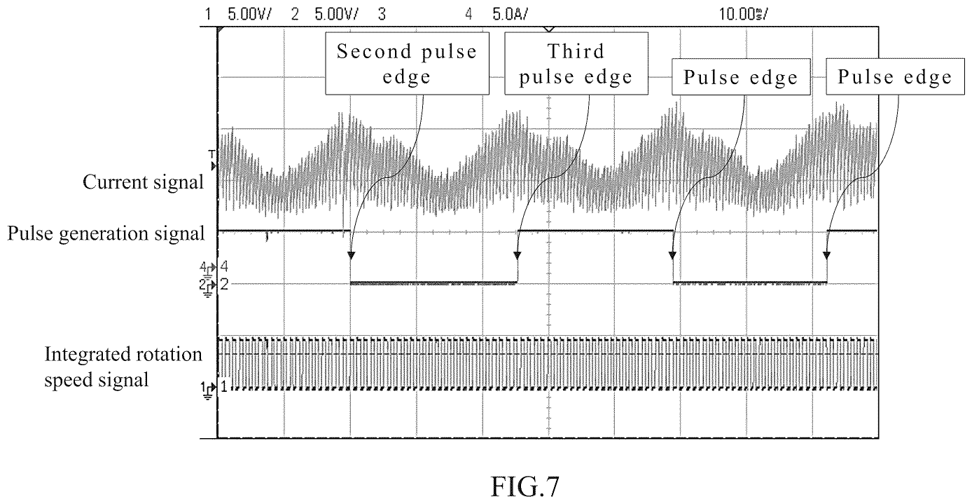

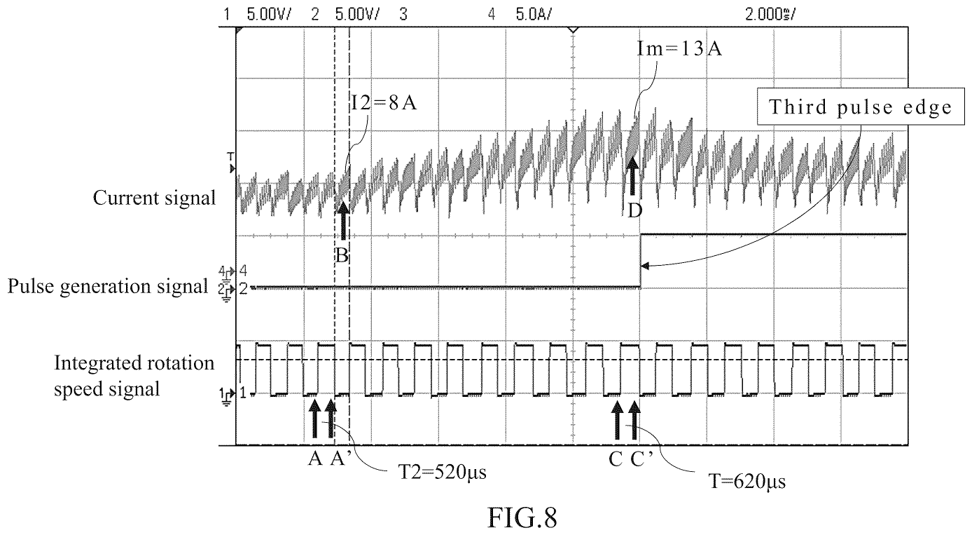

Referring to FIG. 7 and FIG. 8, FIG. 7 is a waveform diagram after a second pulse edge is produced and FIG. 8 is a waveform diagram after a third pulse edge is produced. Although the third pulse edge is produced as an example in FIG. 8, the second pulse edge is formed by the steps identical to the steps which the third pulse edge is formed by, wherein the difference between the second pulse edge and the third pulse edge is that the second pulse edge and the third pulse edge are respectively one of the rising edge and the falling edge. In the current embodiment, after the pulse generation mechanism 14 produces the first pulse, the first control device 18 takes the rotating time T of one of the pulse waves in the integrated rotation speed signal as a second base time T2 (e.g., the rotating time T between an arrow A and an arrow A′ in FIG. 8 is 520 μs) and takes the motor current Im of the current signal as a second base current I2 (e.g., the place pointed by arrow B in FIG. 8 is 8A). Since the process of the rotation of the motor 12 has entered the third load zone, the obtained second base current I2 would be greater than the first base current I1.

In an embodiment, the second base time T2 could be the first base time T1 and the second base current I2 could be the first base current I1, so that the steps of obtaining the second base time T2 and the second base current I2 could be omitted. In an embodiment, the second base time T2 and the second base current I2 could be respectively a time value and a current value predetermined by the first control device 18.

After the pulse generation mechanism 14 produces the first pulse, every time a second condition is satisfied, the first control device 18 transforms a voltage level of the pulse generation signal, i.e., the pulse generation signal is transformed from either the first voltage level V1 or the second voltage level V2 into the other, thereby forming other pulse edges of the pulse wave of the pulse generation signal, i.e., the pulse edges after the second pulse edge.

The second condition is that a ratio of the obtained rotating time T (e.g., the rotating time T between an arrow C and an arrow C′ in FIG. 8 is 620 μs) to the second base time T2 reaches a third ratio and a ratio of the motor current Im (e.g. the place pointed by arrow D in FIG. 8 is 13A) to the second base current I2 reaches a fourth ratio.

In the current embodiment, the second base time T2 is 520 μs as an example and the third ratio is 1.19 as an example. In other words, when the obtained rotating time T is more than 618.8 μs, the third ratio is reached. Preferably, the third ratio ranges between 1.1 and 1.25. In an embodiment, the third ratio ranges between 1.15 and 1.2.

In the current embodiment, the second base current I2 is 8A as an example and the fourth ratio is 1.625 as an example. In other words, when the obtained motor current Im is more than 13A, the fourth ratio is reached. Preferably, the fourth ratio ranges between 1.5 and 4.5. In an embodiment, the fourth ratio ranges between 1.5 and 2. In an embodiment, if the second base current I2 is the first base current I1, the fourth ratio ranges between 3 and 4.5, for example, 4.33 (i.e., 13 A/3 A).

In this way, the first control device 18 could produce the pulse generation signal having the several pulse waves and each of the pulse edges (i.e., the rising edge or the falling edge) of each of the pulse waves corresponds to that the pulse generation mechanism 14 produces each of the pulses. The pulse generation signal is transmitted to the second control device 26 through the feedback signal line 365. The second control device 26 could determine the number of the pulses based on a number of the pulse edges of the pulse generation signal.

Step S15: the second control device 26 receives the pulse generation signal through the feedback signal line 365 and determines the number of the pulse edges of the pulse generation signal. For example, the number of pulse edges is counted as the number of the pulses. The second controller 262 of the second control device 26 compares whether the number of the pulses reaches the predetermined pulse number obtained in step S10.

If the number of the pulses has not reached the predetermined pulse number obtained in step S10, keep the motor 12 continuously rotate.

If the number of pulses reaches the predetermined pulse number obtained in step S10, the braking command is outputted, wherein the braking command is transmitted to the first control device 18 through the brake signal line 364. After the first control device 18 receives the braking command, the first control device 18 controls the motor 12 to stop rotating.

In this way, the control method of the pulse power tool 1 of the current embodiment could accurately determine the number of the pulses produced by the pulse generation mechanism 14 through the motor current Im and the rotating time T of the rotation speed signal and could control the motor 12 to stop rotating when the number of the pulses reaches the required predetermined pulse number, thereby accurately controlling a torque outputted by the pulse power tool 1. In addition, when the output voltage of the battery 30 decreases, the torque is compensated through the compensation pulse number, thereby providing the sufficient torque applied to the workpiece.

Another embodiment is provided below, which could also achieve the effect of accurately controlling a torque output by a pulse power tool.

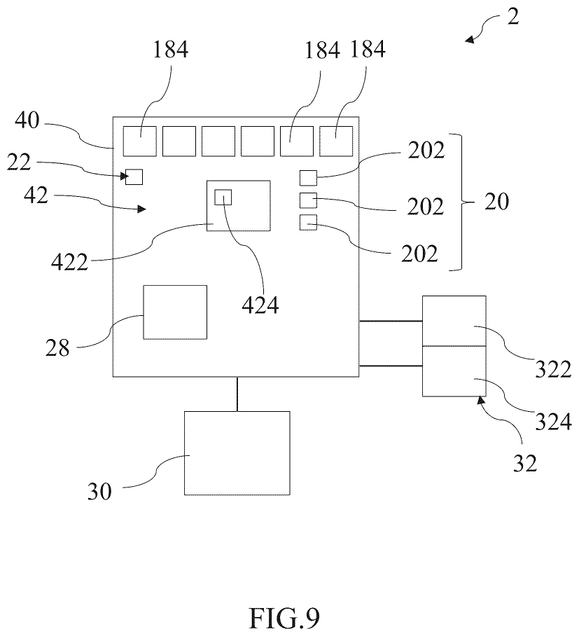

A pulse power tool 2 according to a second embodiment of the present invention is illustrated in FIG. 9. A structure of the pulse power tool 2 is almost the same as a structure of the pulse power tool 1 of the first embodiment, except that the pulse power tool 2 of the current embodiment includes a circuit board 40, wherein a control device 42, the rotation speed detecting device 20, and the current detecting device 22 are disposed on the circuit board 40. The control device 42 includes a controller 422 and the commutation switching elements 184, wherein the controller 422 could be a microcontroller. The controller 422 is electrically connected to the commutation switching elements 184.

The circuit board 40 is electrically connected to the battery 30 and the operation interface 32 and the monitor 28 is disposed on the circuit board 40. The operation interface 32 is electrically connected to the control device 42 and includes the activating switch 322 and the level selecting device 324. The control device 42 detects the output voltage of the battery 30 through the controller 422.

The control device 42 includes a storage unit 424 which is a built-in memory of the controller 422, wherein the storage unit 424 stores a plurality of reference numbers respectively corresponding to the predetermined torque levels. In other words, the storage unit 424 stores the corresponding table as shown in FIG. 1.

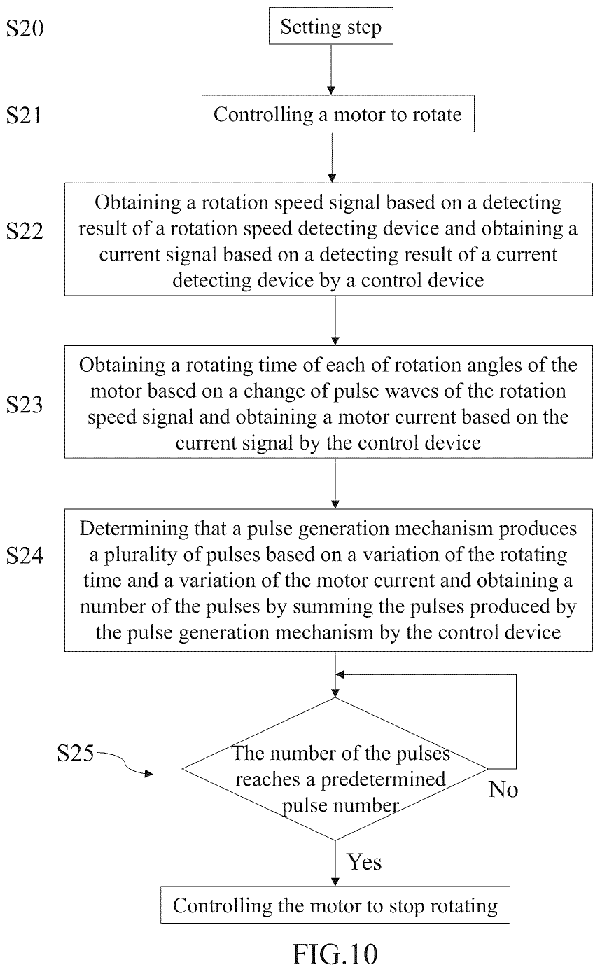

With the aforementioned structure of the pulse power tool 2, a control method as shown in FIG. 10 could be executed and includes following steps:

Step S20: executing a setting step, wherein the setting step is adapted to set a predetermined pulse number. In the current embodiment, the setting step of the second embodiment is almost the same as the setting step of the first embodiment, except that the predetermined pulse number is set by the controller 422 of the control device 42.

Step S21: controlling the motor 12 to rotate.

After the user lightly presses the activating switch 322, the activating switch 322 outputs the first activating signal to the controller 422 and the controller 422 controls the motor 12 to rotate by controlling the commutation switching elements 184. At that time, the rotating shaft 122 of the motor 12 drives the pulse generation mechanism 14 to rotate and the output shaft 142 drives the workpiece to rotate.

Step S22: the control device 42 continuously obtains the rotation speed signal based on a detecting result of the rotation speed detecting device 20 and obtains the current signal based on a detecting result of the current detecting device 22.

Step S22 of the current embodiment is almost the same as step S12 of the first embodiment, except that the original rotation speed signal does not be converted into the integrated rotation speed signal.

After the user heavily presses the activating switch 322, the activating switch 322 outputs the second activating signal to the controller 422 and the controller 422 controls the commutation switching elements 184 to make the motor 12 rotate at a fixed rotation speed.

Step S23: the control device 42 obtains the rotating time T of each of the rotation angles of the motor 12 according to the variation of the pulse waves of the original rotation speed signal and obtains the motor current Im based on the current signal.

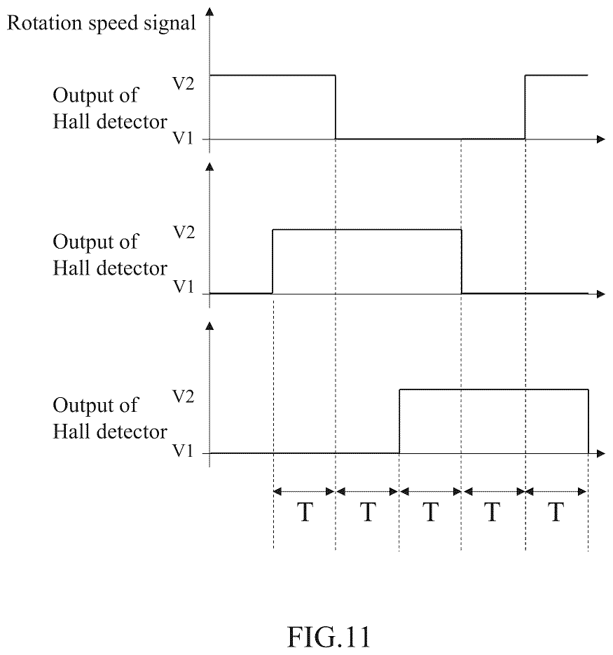

Referring to FIG. 11, in the current embodiment, since the identical control device 42 performs control, the difference between the control method of the current embodiment and the control method of the first embodiment is that the rotating time T of each of the rotation angles of the motor 12 is obtained according to a variation of the pulse waves of the three outputs of the three Hall detectors 202 in the original rotation speed signal. The time difference between a time that the pulse wave of the output of one of the three Hall detectors 202 varies and a time that the pulse wave of the output of another one of the three Hall detectors 202 varies is the rotating time T.

After the motor 12 rotates at the fixed rotation speed, the control device 42 takes one of the rotating times T in the rotation speed signal as a first base time T1 and takes the motor current Im in the current signal as a first base current I1, wherein the way to obtain the first base time T1 and the first base current I1 is identical to the way of the first embodiment.

Step S24: the control device 42 determines that the pulse generation mechanism 14 produces the pulses and a number of the pulses according to the variation of the rotating time T of the rotation speed signal and the variation of the motor current Im of the current signal.

Step S24 of the current embodiment is almost the same as step S14 of the first embodiment. That the pulse generation mechanism 14 produces the first pulse when a first condition is satisfied is determined in both step S24 of the current embodiment and step S14 of the first embodiment, wherein the first condition is that a ratio of the obtained rotating time T to the first base time T1 reaches a first ratio and a ratio of the motor current Im to the first base current I1 reaches a second ratio.

Additionally, the difference between step S24 of the current embodiment and step S14 of the first embodiment is that the control device 42 does not produce the pulse generation signal.

After that, the at least one of the pulses produced by the pulse generation mechanism 14 is determined after the first pulse when a second condition is satisfied, wherein the second condition is that a ratio of the obtained rotating time T to a second base time T2 reaches a third ratio and a ratio of the motor current Im to a second base current I2 reaches a fourth ratio; the way to obtain the second base time T2 and the second base current I2 is identical to the way of the first embodiment.

Step S25: the controller 422 of the control device 42 counts the number of the pulses and compares whether the number of the pulses reaches the predetermined pulse number.

If the number of the pulses has not reached the predetermined number, keep the motor 12 continuing to rotate.

If the number of pulse reaches the predetermined number, the motor 12 is controlled by the controller 422 to stop rotating.

In this way, the control method of the current embodiment could control the motor 12 to stop rotating when the number of the pulses reaches the required predetermined pulse number, thereby accurately controlling a torque outputted by the pulse power tool 2 as well. In addition, when the output voltage of the battery 30 decreases, the torque is compensated through the corresponding compensation pulse number, thereby providing the sufficient torque applied to the workpiece.

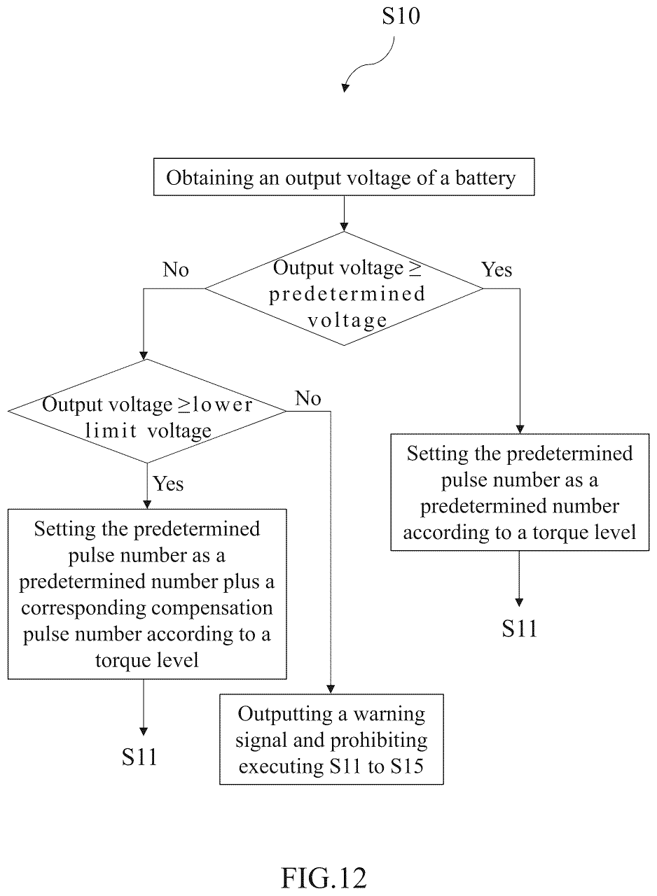

A setting step of a control method of a pulse power method according to a third embodiment of the present invention is illustrated in FIG. 12 and is based on the setting step of the first embodiment, except that:

The second control device 26 predetermines a lower limit voltage, wherein the lower limit voltage is less than the predetermined voltage and could be stored in the storage unit 264 to be read by the second controller 262. In the setting step of step S10, when the second controller 262 determines that the output voltage is less than the predetermined voltage and is greater than or equal to the lower limit voltage, the second controller 262 sets that the predetermined pulse number is equal to the predetermined number plus the corresponding compensation pulse number according to the torque level and then step S11 is executed. When the second controller 262 determines the output voltage is less than the predetermined voltage and is less than the lower limit voltage, the second controller 262 outputs a warning signal and step S11 to step S15 are prohibited from being executed, thereby preventing the battery 30 from excessively discharging. In the current embodiment, the warning signal could be transmitted to the monitor 28 to be displayed by the monitor 28 as an example.

The setting step of the third embodiment could also be executed in the second embodiment and the difference between the setting step of the current embodiment and the setting step of the second embodiment is that the controller 422 determines the output voltage and outputs the warning signal.

It must be pointed out that the embodiments described above are only some preferred embodiments of the present invention. All equivalent methods which employ the concepts disclosed in this specification and the appended claims should fall within the scope of the present invention.

What is claimed is:

1. A control method of a pulse power tool, wherein the pulse power tool comprises a motor, a pulse generation mechanism, a rotation speed detecting device, a current detecting device, and at least one control device; the pulse generation mechanism is coupled to the motor and is driven by the motor to rotate; the rotation speed detecting device is adapted to detect a rotation speed of the motor and the current detecting device is adapted to detect a motor current when the motor operates; the control method of the pulse power tool is executed by the at least one control device and comprises the following steps:
step A: executing a setting step adapted to set a predetermined pulse number and comprising the following steps:
obtaining an output voltage of a battery;
determining if the output voltage is greater than or equal to a predetermined voltage;
if the output voltage is greater than or equal to the predetermined voltage, the predetermined pulse number is set as a predetermined number according to a torque level;
if the output voltage is not greater than or equal to the predetermined voltage, the predetermined pulse number is set as the predetermined number plus a corresponding compensation pulse number according to the torque level;
step B: controlling the motor to rotate;
step C: continuously obtaining a rotation speed signal based on a detecting result of the rotation speed detecting device and obtaining a current signal based on a detecting result of the current detecting device, wherein the rotation speed signal has a plurality of pulse waves corresponding to a plurality of rotation angles of the motor; obtaining a rotating time of each of the plurality of rotation angles of the motor based on a variation of the plurality of pulse waves and obtaining the motor current based on the current signal;
step D: determining that the pulse generation mechanism produces a plurality of pulses based on a variation of the rotating time of the rotation speed signal and a variation of the motor current of the current signal, and obtaining a number of the plurality of pulses by summing the plurality of pulses produced by the pulse generation mechanism;
step E: determining if the number of the plurality of pulses reaches the predetermined pulse number; if the number of the plurality of pulses has not reached the predetermined pulse number, keep the motor continuously rotating; if the number of the pulses reaches the predetermined pulse number, stop the motor from rotating.

2. The control method of the pulse power tool as claimed in claim 1, further comprising the following steps before step A:
providing a storage unit, wherein the storage unit stores a plurality of reference numbers and a plurality of reference compensation pulse number groups; the plurality of reference numbers respectively correspond to a plurality of predetermined torque levels; each of the plurality of reference compensation pulse number groups corresponds to each of the plurality of reference numbers; each of the plurality of reference compensation pulse number groups comprises a plurality of reference compensation pulse numbers, wherein each of the plurality of reference compensation pulse numbers of each of the plurality of reference compensation pulse number groups corresponds to a reference voltage difference;
wherein in step A, one of the plurality of predetermined torque levels is selected according to a level selecting signal to form the torque level; corresponding one of the plurality of reference numbers is obtained from the storage unit according to one of the plurality of predetermined torque levels corresponding to the level selecting signal to form the predetermined number;
when the output voltage is less than the predetermined voltage, a voltage difference is obtained through the predetermined voltage minus the output voltage and corresponding one of the plurality of reference compensation pulse numbers is obtained from the storage unit according to one of the plurality of predetermined torque levels and the voltage difference corresponding to the level selecting signal to form the corresponding compensation pulse number.

3. The control method of the pulse power tool as claimed in claim 2, wherein in step A, one of the reference compensation pulse numbers corresponding to one of the reference voltage differences which is identical to or similar to the voltage difference is selected to form the corresponding compensation pulse number.

4. The control method of the pulse power tool as claimed in claim 2, wherein in step A, when the voltage difference is a mean of the two adjacent reference voltage differences, the two reference compensation pulse numbers corresponding to the two adjacent reference voltage differences are averaged to obtain the corresponding compensation pulse number.

5. The control method of the pulse power tool as claimed in claim 1, wherein in step A, when that the output voltage is less than the predetermined voltage and is greater than or equal to a lower limit voltage is predetermined, the predetermined pulse number is set to be equal to the predetermined number plus the corresponding compensation pulse number according to the torque level; when that the output voltage is less than the predetermined voltage and is less than the lower limit voltage is predetermined, a warning signal is outputted and step B to step E are prohibited from being executed.

6. The control method of the pulse power tool as claimed in claim 1, wherein the predetermined voltage is less than a rated voltage of the battery.
